(19) United States
(12) Patent Application Publication
(10) Pub. No.: US 2015/0147061 A1
(43) Pub. Date: May 28, 2015

(54) COMBINATION CUSTOMER SPLICE POINT MODULE AND OPTICAL NETWORK TERMINAL MOUNT

(71) Applicant: OFS Fitel, LLC, Norcross, GA (US)

(72) Inventors: Denis E. Burek, Cumming, GA (US); Willard C. White, Suwanee, GA (US)

(21) Appl. No.: 14/405,160

(22) PCT Filed: Feb. 5, 2013
(86) PCT No.: PCT/US13/24725

§ 371 Date: Dec. 3, 2014

Related U.S. Application Data
(60) Provisional application No. 61/665,565, filed on Jun. 28, 2012.

(51) Int. Cl. H04B 10/2575; H04B 10/40

(52) U.S. Cl. CPC H04B 10/25752; H04B 10/40
USPC 398/66

(57) ABSTRACT

The specification described a multifunction CSP (MCSP), and a MCSP/ONT assembly that is adapted for mounting inside the customer premises. In the MCSP/ONT assembly the MCSP subunit and the ONT subunit are stacked and attached directly together. The MCSP/ONT assembly combines the functions of the standard CSP box and the ONT box, thus eliminating the need for the building cable. In addition the MCSP subunit is adapted to integrate more than one ONT in the MCSP/ONT assembly. The MCSP subunit comprises a back box, a splice tray, and a cover.

### RELATED APPLICATIONS

This application claims the benefit of provisional application 61/665,565, filed Jun. 28, 2012, which is incorporated herein by reference.

### FIELD OF THE INVENTION

This invention relates to connector boxes for optical network terminals. They are specially adapted for drop line installations in a Passive Optical Network (PON).

### BACKGROUND OF THE INVENTION

(Parts of this background may or may not constitute prior art.) Fiber-to-the-premises (FTTP) from local telephone and cable service providers is a rapidly growing technology. This service requires a broadband optical fiber distribution network comprising local optical fiber distribution cables that are installed in neighborhoods and city streets. These are commonly referred to as Passive Optical Networks (PONs). Single fiber or low fiber count cables are used for the “drop” line from the street to the premises. The drop line is sometimes referred to as an Out Side Plant (OSP) cable.

The OSP cable is typically terminated at a Customer Splice Point module (CSP) mounted on the outside walls of the customer premises location. From there, a premises building cable is used to connect the CSP on the outside of the building to an indoor wall mounted Optical Network Terminal (ONT). The premises building cable typically penetrates through a wall of the customer premises.

The terms ONT, PON, CSP are designated by the Telecommunication Standardization Sector (ITU-T). The ITU-T is one of the three sectors (divisions or units) of the International Telecommunications Union (ITU). These sectors coordinate standards for telecommunications. Thus these designations are well known and recognized in the art and are used herein for their standard meaning.

### STATEMENT OF THE INVENTION

We have designed a multifunction CSP (MCSP), and a MCSP/ONT assembly that is adapted for mounting inside the customer premises. In the MCSP/ONT assembly the MCSP subunit and the ONT subunit are stacked and attached directly together. The MCSP/ONT assembly combines the functions of the standard CSP box and the ONT, thus eliminating the need for the building cable. In addition the MCSP subunit is adapted to integrate more than one ONT in the MCSP/ONT assembly. The MCSP subunit comprises a back box, a splice tray, and a cover.

### BRIEF DESCRIPTION OF THE DRAWING

The invention may be more clearly described with the aid of the drawing, in which:

FIG. 1 is a perspective view of the MCSP subunit showing the three elements of the MCSP box, the back box, the splice tray and the cover, in a partially exploded view with the splice tray open;

FIG. 2 is a perspective view of the back box of the MCSP subunit;

FIG. 3 is a perspective view of the splice tray of the MCSP subunit;

FIG. 4 is a perspective view of the front cover of the MCSP subunit;

FIG. 5 is a perspective view of the MCSP subunit showing the three elements, the back box, the splice tray and the cover, in a partially exploded view with the splice tray closed;

FIG. 6 is a perspective view of the MCSP subunit showing the back box, the splice tray, and the cover, with the cover closed;

FIG. 7 is a schematic view of the MCSP/ONT assembly of the invention; and

FIG. 8 shows dimensional features used in defining the MCSP/ONT assembly.

### DETAILED DESCRIPTION

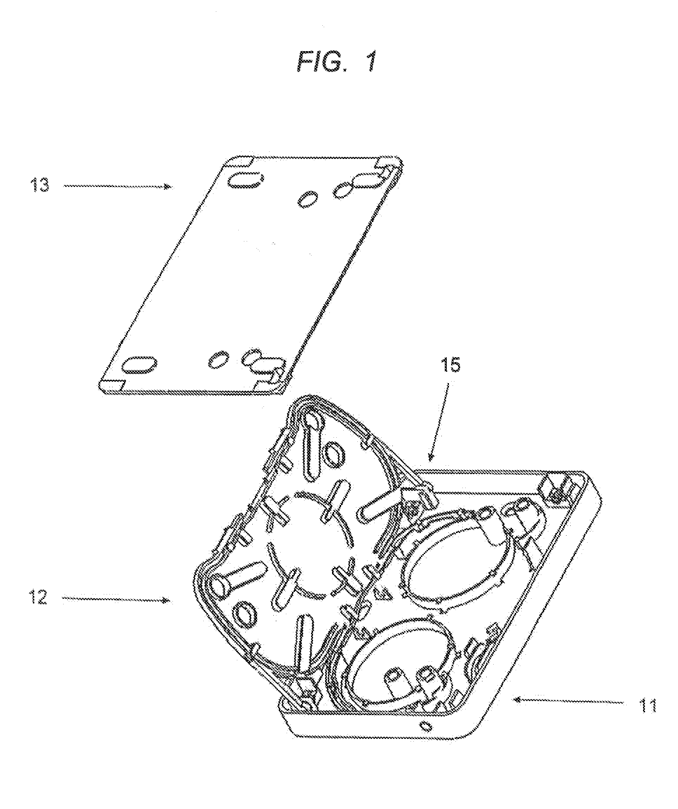

Referring to the drawing, FIG. 1 is a perspective view of the MCSP subunit, exploded for clarity, showing a back box 11, a splice tray 12 and a cover 13. The splice tray is attached to the back box with hinges 15. The MCSP subunit is functionally similar to a standard CSP, but is modified for attaching to one or more ONT subunits.

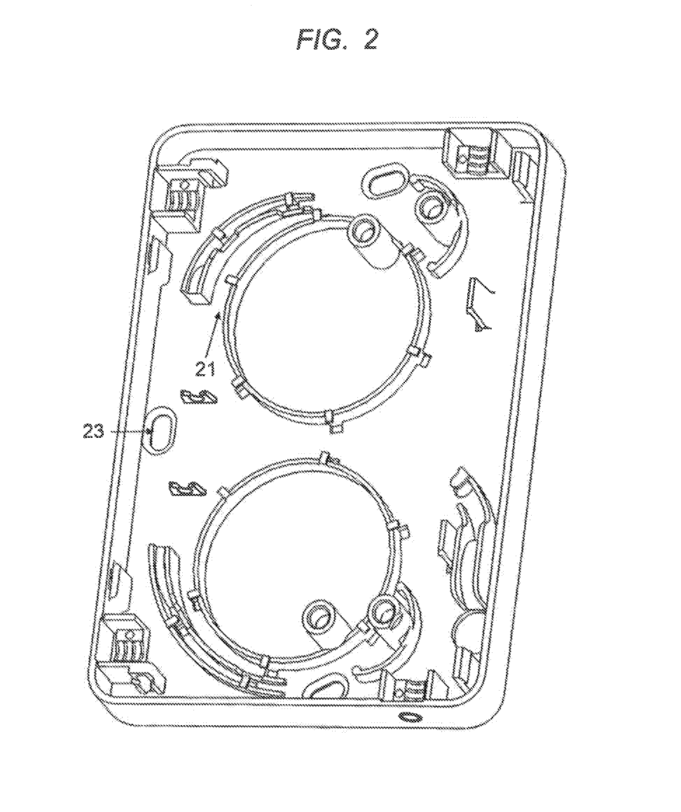

FIG. 2 is a perspective view of the back box of the MCSP subunit showing raised channel features, e.g. chase 21, for routing optical fibers within the back box. FIG. 2 also indicates at 23 one of several holes used to mount the back box to a customer premises.

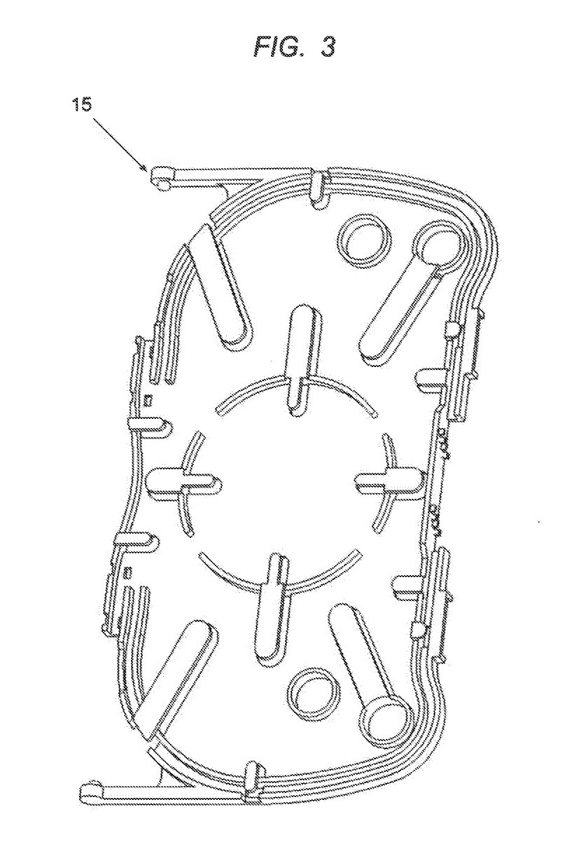

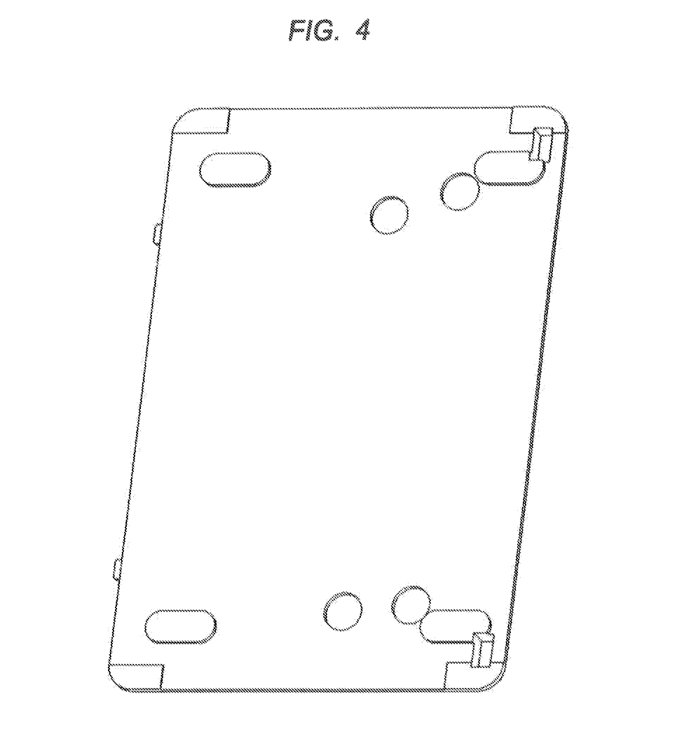

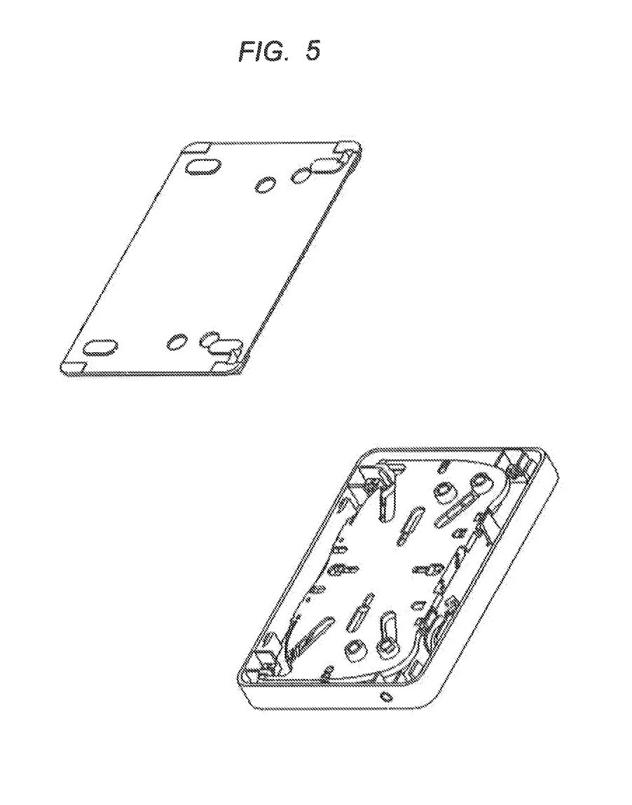

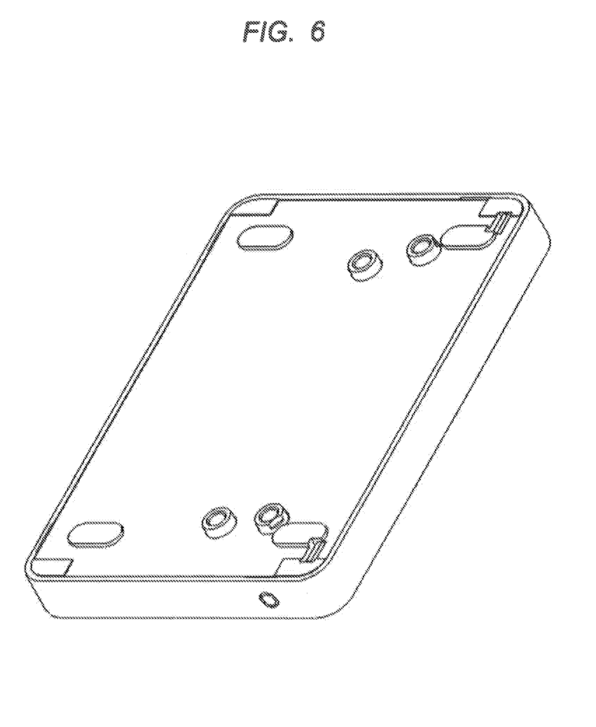

FIG. 3 shows the splice tray of the MCSP subunit in greater detail. The hinges for attaching the MCSP splice tray to the MCSP back box are shown at 15. FIG. 4 shows the front cover in more detail. FIG. 5 shows the MCSP back box and the MCSP splice tray, with the splice tray closed and the cover exploded. FIG. 6 shows the closed MCSP subunit. It should be understood that the details of the interior of the MCSP box may have a wide variety of configurations and internal functions. Those illustrated here are of a preferred example. Namely, the preferred example comprises a MCSP subunit having a back box, an essentially planar tray attached to the back box with hinges to allow the tray to be folded alternately into and outward of the back box, and a front cover to enclose the MCSP subunit.

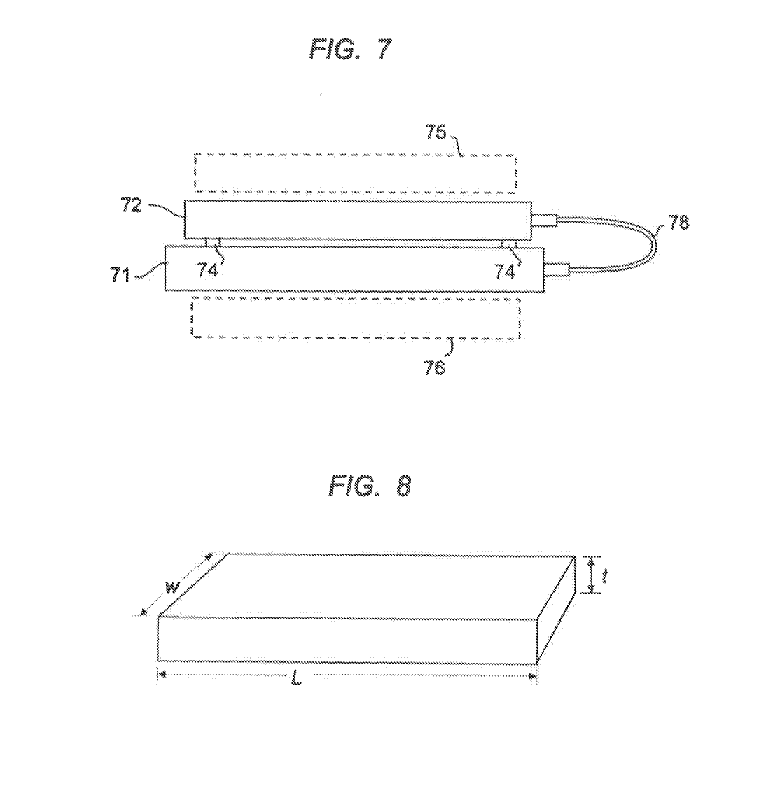

The MCSP/ONT assembly of the invention is shown schematically in FIG. 7. The MCSP subunit is shown at 71, with a stacked ONT subunit shown at 72. The subunits attached together with fasteners 74. Optional additional ONT subunits are shown in phantom at 75, attached to ONT subunit 72, and at 76, attached to the other side of the MCSP subunit 71.

An optical fiber cable 78 is connected to both the MCSP and the ONT. Other interconnections, e.g., the cable interconnecting the MCSP subunit to the OSP, and the cable and wire connections from the ONT subunit to the customer network, are not shown for clarity. It will be recognized that in this installation the optical fiber in the cable connecting the MCSP subunit and the ONT subunit may be uninterrupted, i.e., it is unspliced.

FIG. 8 is added to describe parameters useful in defining the MCSP/ONT assembly of the invention. It shows generally a box having a length L, width w, and thickness t. A box, according to accepted common meaning, is a container having a flat base, four sides, and a cover. The base and cover have approximately matching length and width. The sides have thickness t. The elements are quadrilateral and nominally rectilinear. Some elements may be square. It may be possible for some equivalent designs to have a circular shape, or other convenient shape.

For typical CSP and ONT subunits, t is less than w or L. Thus the sides of these subunits are rectangular. The base and cover may be square or rectangular. They are defined generally as quadrilateral.

It should be understood that the stacking arrangement may take a variety of forms. FIG. 7 illustrates a few options. In other options, ONT subunits 72 and 75 may be smaller, and both attached side-by-side to MCSP 71. The ONT subunit may be stacked with the length either parallel or perpendicular to the MSCP subunit. In the preferred stacking arrangement the ONT subunit is stacked with the ONT subunit attached to the cover, or other part(s), of the

MCSP subunit. The ONT subunit may be attached cover to cover with the MCSP subunit, or the base of either subunit may be attached to the cover of the other subunit. The term stacked and attached would ordinarily be interpreted as a length/width face of one subunit attached to a length width face of the other subunit. One or both of the subunits, the MCSP subunit and/or the ONT subunit, is/are provided with one or more fasteners to attach the MCSP subunit and the ONT subunit together to form the MCSP/ONT assembly. The fasteners may have one or more of a variety of forms, e.g., adhesive, Velcro, threaded elements, twist locks, press/snap fittings, or any instrumentality performing an equivalent function of holding the two boxes together. The boxes may be in mutual contact or close proximity to one another. Close proximity, in the context of the invention, means within a single length of the largest box.

As suggested earlier, the size and shape of the ONT and MCSP subunits may vary widely. While these containers are normally box shaped, they may have other shapes. The base, sides and cover may be rectilinear, or may have turned edges, lips, ledges, etc. to aid in effecting closure, or sealing the container. For example, the base, sides, and cover of the MCSP subunit shown in FIG. 1 are not precisely rectangular. The box described above has a base and a cover. Alternatively, a box may have sides and two covers.

As described earlier, the MCSP/ONT assembly is adapted to be installed inside a customer premises. In prior art installations, a through-wall interconnection is made between the CSP and the ONT. The “wall” refers to a wall of a customer premises. Using an MCSP/ONT assembly according to the invention, that through-wall interconnection is eliminated, allowing a typically shorter path interconnection between the MCSP and the ONT. Thus the optical fiber 78 in FIG. 7, may have a length of less than, for example, four lengths of the MCSP subunit.

Various other modifications of this invention will occur to those skilled in the art. All deviations from the specific teachings of this specification that basically rely on the principles and their equivalents through which the art has been advanced are properly considered within the scope of the invention as described and claimed.

1. A telecommunications interface for interconnecting an Outside Plant (OSP) cable to a telecommunications network inside a customer premises comprising:
a. a Multifunction Customer Splice Point (MCSP) subunit,
b. an Optical Network Terminal (ONT) subunit,
wherein the MCSP subunit and the ONT subunit are attached together to form an MCSP/ONT assembly.

2. The telecommunications interface of claim 1 wherein the MCSP and the ONT are stacked.

3. The telecommunications interface of claim 2 wherein the MCSP/ONT assembly is mounted on the inside of a customer premises.

4. The telecommunications interface of claim 3 wherein the MCSP and/or the ONT are/is provided with a fastener for fastening the MCSP and the ONT together.

5. The telecommunications interface of claim 4 wherein the MCSP and the ONT are stacked.

6. The telecommunications interface of claim 5 wherein an unspliced optical fiber connects the MCSP subunit and the ONT subunit.

7. The telecommunications interface of claim 5 wherein two or more ONT subunits are attached to the MCSP subunit.

8. The telecommunications interface of claim 5 wherein the MCSP subunit comprises a back box, a splice tray and a cover.

9. The telecommunications interface of claim 8 wherein the MCSP is attached to an interior wall of a customer premises and the ONT is attached to the MCSP.

10. The telecommunications interface of claim 9 wherein the ONT is attached to the back box of the MCSP with threaded members that extend through the cover of the MCSP.

11. The telecommunications interface of claim 6 wherein the unspliced fiber has a length less than four lengths of the MCSP subunit.
